(19) United States
(12) Patent Application Publication
(10) Pub. No.: US 2006/0224763 A1
(43) Pub. Date: Oct. 5, 2006

(54) Switching and simultaneous usage of 802.11a and 802.11g technologies for video streaming

(75) Inventors: Yucel Altunbasak, Norcross, GA (US); Mehmet Umut Demircin, Marietta, GA (US)

Correspondence Address: MICHAEL BLAINE BROOKS, PC, P.O. BOX 1630, SIMI VALLEY, CA, 93062-1630, US

(73) Assignee: Sharp Laboratories of America, Inc.

(21) Appl. No.: 11/375,087

(22) Filed: Mar. 13, 2006

Related U.S. Application Data
(60) Provisional application No. 60/663,162, filed on Mar. 18, 2005.

(51) Int. Cl. G06F 15/16

(52) U.S. Cl. 709/231

(57) ABSTRACT

The embodiments of the present invention provide methods, devices, and systems wherein a server is able to transmit streaming content elements of a source content via a first wireless channel and a second wireless channel. The transmission via these two channels may be performed simultaneously with each other or performed alternating with each other. The first wireless channel and the second wireless channel are different from each other.

### CROSS-REFERENCE TO RELATED APPLICATIONS

This application claims the benefit of U.S. Provisional patent Application Ser. No. 60/663,162 filed Mar. 18, 2005, entitled “Switching and Simultaneous Usage of 802.11a and 802.11g Technologies for Video Streaming,” which is hereby incorporated by reference herein in its entirety for all purposes.

### BACKGROUND

Local area networks (LANs), e.g., in a home or office setting, are steadfastly being used as a means to obtain entertainment. In particular, these networks are used as conduits so as to send and receive digital audiovisual (AV) data, e.g., streaming videos, streaming music, and movies on-demand. Wireless LANs are also gaining popularity and are now being used as channels to send streaming AV data from a media source to a media player.

Wireless LAN technologies are typically advantageous due to their relatively high bit rates, relatively good range, ease of deployment (no new wiring required), availability of standards (IEEE 802.11), its rapid adoption in the marketplace, and industry support. For example, IEEE 802.11a and 802.11g wireless local area network (WLAN) technologies operate at 5 GHz and 2.4 GHz, respectively. Various wireless appliances and devices, such as cordless phones, BLUETOOTH™ devices, microwave ovens, however, are possible sources of interference for WLANs at both 2.4 GHz and 5 GHz frequency bands.

Interference causes bandwidth degradation, which may result in a poor quality AV stream. This may, for example, result in having a streaming video played back with jitters, having the video freeze, and/or played with missing video frames. Furthermore, in some conditions, the capabilities of the local wireless networks are not well matched to the stringent requirements imposed by AV data transmission. In terms of data throughput offered, WLANs are typically inherently unpredictable and change dynamically due to varying usage conditions.

Streaming AV data over a LAN is challenging due to strict requirements on network bandwidth, overall quality, and ease of installation and use. The following are some examples of typical bandwidth requirements for real-time streaming of AV data at an acceptable quality:
CD Audio: ˜1 Mbps;
Standard definition (SD) video (Moving Picture Experts Group-2 (MPEG-2)): ˜6 Mbps;
High definition (HD) video (MPEG-2): ˜20 Mbps; and
Multiple AV streams: ˜50-150 Mbps.

Methods, systems, and devices that improve audio, visual or image, and/or audiovisual data transmission over wireless networks are thus highly desirable.

### SUMMARY

In one aspect of the invention, a method of delivering, via a server, a streaming source content is provided. The source content includes a set of content elements. The method includes the steps of transmitting, by the server, via a first wireless channel at least one streaming content element of the source content, and transmitting, by the server, via a second wireless channel at least one streaming content element of the source content.

The second wireless channel is different from the first wireless channel. Furthermore, the step of transmitting via the second channel is selected from at least one of the following: performed simultaneously with the step of transmitting via the first channel, and performed in an alternating manner with the step of transmitting via the first channel.

In another aspect, a media server that is adapted to be operably coupled to a wireless network and to deliver a streaming source content is provided. The source content includes a set of content elements. The media server includes a first wireless channel interface, a second wireless channel interface that is different from the first wireless channel interface, and a content network adaptation module. The content network adaptation module is adapted to transmit via the first channel interface at least one streaming content element of the source content, and transmit via the second channel interface at least one streaming content element of the source content. Moreover, the transmission via the second channel interface is at least one of the following: performed simultaneously with the transmission via the first channel interface, and performed in an alternating manner with the transmission via the first channel interface.

In another aspect of the invention, a media receiver is provided that is adapted to be operably coupled to a wireless network and to receive a streaming source content from a server. The receiver includes a first wireless channel interface, a second wireless channel interface that is different from the first wireless channel interface, and a content network adaptation module. The content network adaptation module is adapted to receive via the first channel interface at least one streaming content element of the source content, and receive via the second channel interface at least one streaming content element of the source content. Moreover, the reception via the second channel interface is at least one of the following: performed simultaneously with the reception via the first channel interface, and performed in an alternating manner with the reception via the first channel interface.

In another aspect of the invention, a system is provided. This system includes at least one wireless network segment operably coupling a media server and a media receiver, the media server, and the media receiver. The media server includes a first wireless channel interface, a second wireless channel interface that is different from the first wireless channel interface, and a content network adaptation module. The media server's content network module is adapted to transmit via the first channel interface at least one streaming content element of the source content, and transmit via the second channel interface at least one streaming content element of the source content, wherein the transmission via the second channel interface is at least one of the following: performed simultaneously with the transmission via the first channel interface, and performed in an alternating manner with the transmission via the first channel interface. The media receiver, on the other hand, includes a first wireless channel interface, a second wireless channel interface that is different from the first wireless channel interface, and content network adaptation module. The media receiver's content module is adapted to receive via the first channel interface at least one streaming content element of the source content, and receive via the second channel interface at least one streaming content element of the source content, wherein the reception via the second channel interface is at least one of the following: performed simultaneously with the reception via the first channel interface, and performed in an alternating manner with the reception via the first channel interface.

### BRIEF DESCRIPTION OF THE DRAWINGS

The present invention is illustrated by way of example and not limitation in the figures of the accompanying drawings, and in which:

FIG. 1 is an exemplary network according to an embodiment of the invention;

FIG. 2 is a high-level data flow diagram showing a process of simultaneous transmission via two wireless channels, according to an embodiment of the invention;

FIG. 3 is a high-level data flow diagram showing a process of alternate switching transmission between two wireless channels, according to an embodiment of the invention;

FIG. 4 is an exemplary data flow, when a switch is made from one wireless channel to another, according to an embodiment of the invention;

FIGS. 5 and 6 are exemplary data flow diagrams showing simultaneous transmission of redundant source contents, according to embodiments of the invention;

FIG. 7 is an exemplary data flow showing simultaneous transmission of a source content partitioned between the available wireless channels, according to an embodiment of the invention;

FIG. 8 is an exemplary data flow showing simultaneous transmission of a source content, with partial redundancy, between the available wireless channels, according to an embodiment of the invention;

FIG. 9 is a variation of FIG. 8 but with a retransmission-based loss recovery feature, according to an embodiment of the invention;

FIG. 10 is an exemplary data flow showing simultaneous transmission of descriptions, according to an embodiment of the invention;

FIG. 11 is an exemplary data flow showing simultaneous transmission of scalable layers, according to an embodiment of the invention;

FIG. 12 is an exemplary flowchart showing how a switch from one wireless channel to another may be performed, according to an embodiment of the invention; and

FIG. 13 is a functional block diagram of an exemplary device that may be operably coupled to a wireless network, according to an embodiment of the invention.

### DETAILED DESCRIPTION

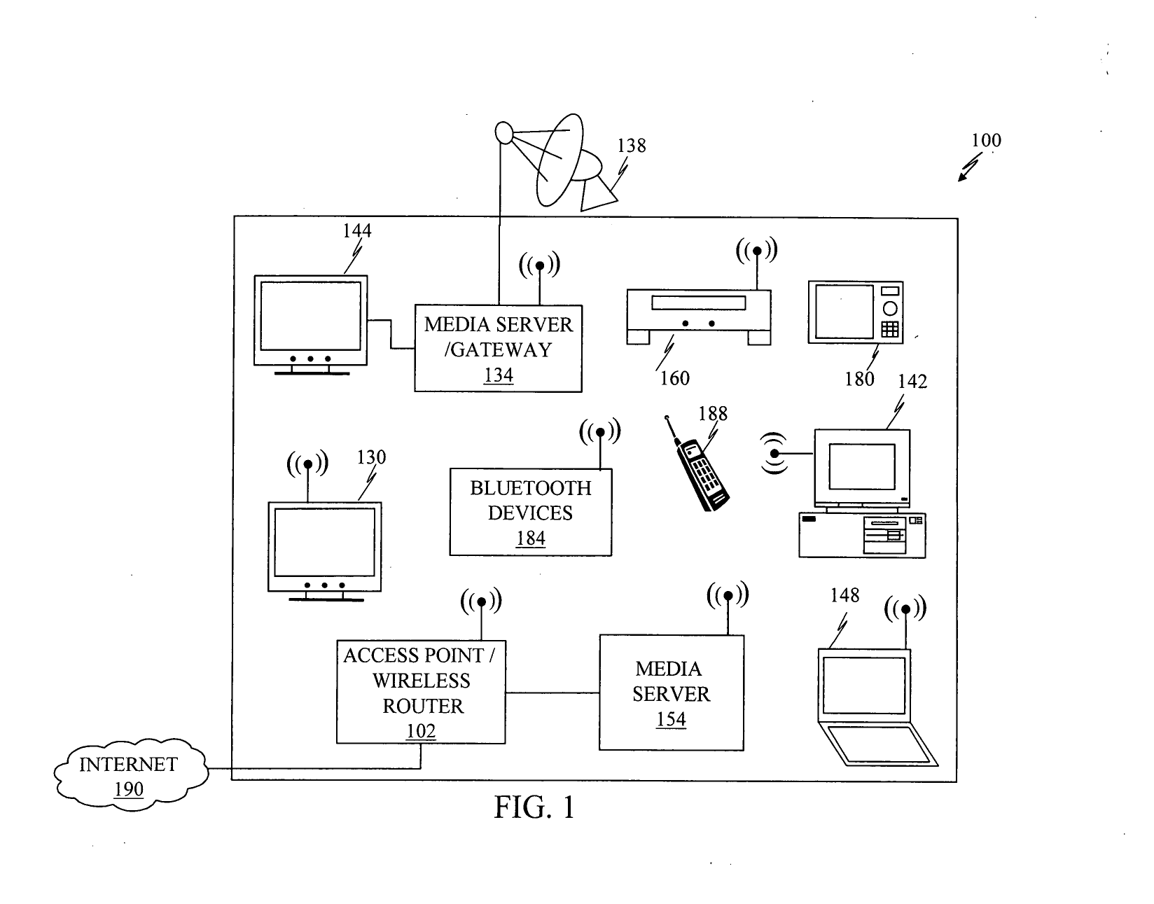

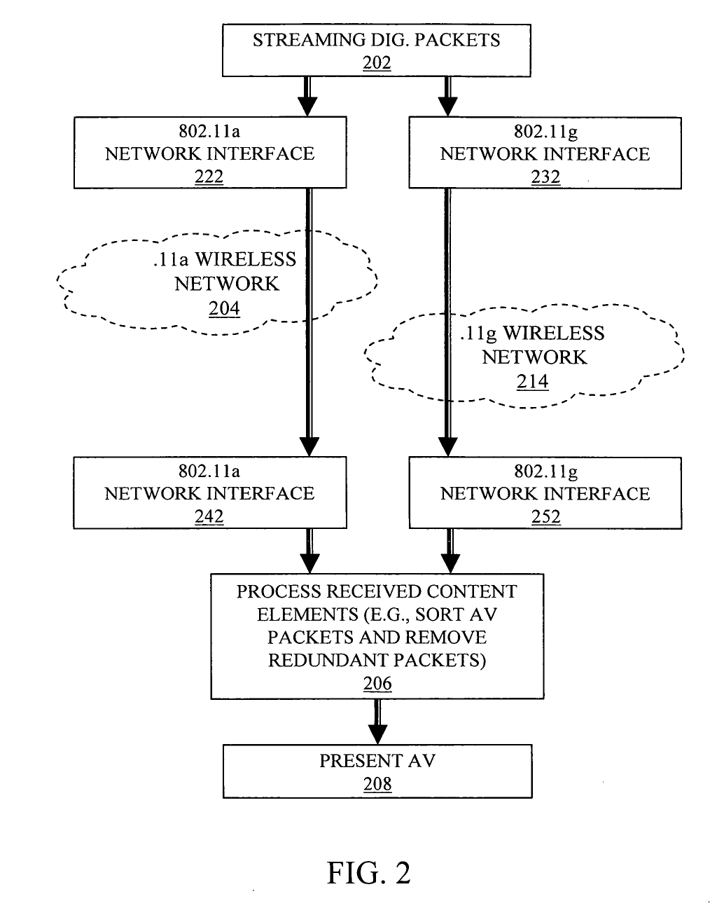

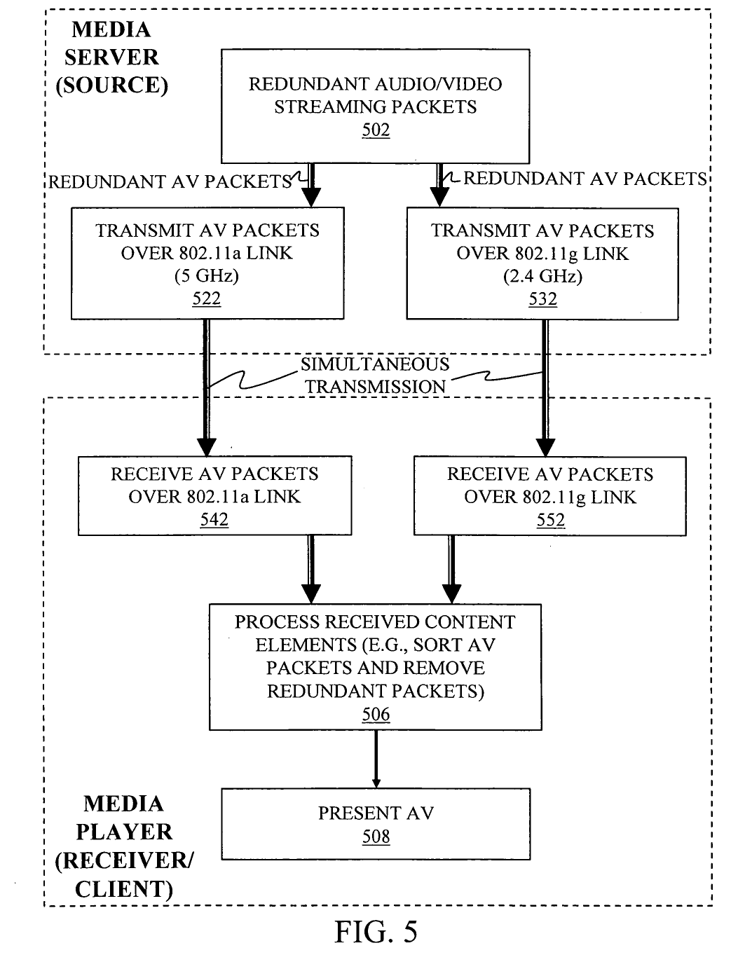

To better understand the figures, reference numerals within the one hundred series, for example, 134 and 190, are initially introduced in FIG. 1, reference numerals in the two hundred series, for example, 222 and 252, are initially introduced in FIG. 2, and so on and so forth. So, reference numerals in the five hundred series, e.g., 522 and 532, are initially introduced in FIG. 5.

The embodiments of the present invention typically address wireless networks, particularly, streaming contents via at least two frequency channels, e.g., those supporting the IEEE 802.11a and 802.11g specifications. IEEE 802.11a and 802.11g WLAN technologies operate at 5 GHz and 2.4 GHz, respectively. IEEE 802.11a and 802.11g are also referred herein as “.11a” and “.11g.” In some embodiments, the transmissions of these streaming contents are either simultaneous or alternating between the two available frequency channels.

Video streaming in general, for example, for on-demand movies, typically involves defining the source content, e.g., video or movie, into content elements, transmitting these elements in succession, and decoding and playing back (playback) these elements at the receiver while the video is still being delivered and without having to wait for the entire video to be delivered. The video content is typically encoded, including compressed, and stored prior to transmission. In some embodiments, this video content may be encoded for real-time or substantially real-time communication, for example, during video conferencing. The source content may also be previously stored and encoded, e.g., movies stored in digital video discs (DVDs).

A source content typically consists of a set of content elements. These content elements, typically depending on implementation, may be frames, packets, group of pictures (GOPs), slices, and other data units. The embodiments of the present invention thus deliver a source content by transmitting or streaming the content elements of that source content between a media server and at least one receiver, e.g., a media player, via at least two wireless frequency channels. In some embodiments, redundant source contents are transmitted such that the server is adapted to transmit two copies of the same content to the same media player. These redundant source contents, however, may be represented into two different stream sets. For example, one set of streaming content elements, e.g., streaming packets, are transmitted at 2.4 GHz and are encoded at a different frame rate and bit rate as compared to the other stream set transmitted at 5 GHz. In some embodiments, the streaming content elements are exact duplicates. Examples of source contents include on-demand movies, on-demand music, real-time radio, and the like.

If there are interferences, for example, at the 2.4 GHz transmission that result in having packets lost or delayed, a redundant copy of that content which is transmitted over the other frequency channel, e.g., at 5 GHz, may have a chance to be received by a client device, assuming that there is little or no interference at the 5 GHz frequency. In other embodiments, the source content is divided or partitioned, and each frequency channel transmits its respective allocated content elements of the source content.

FIG. 1 is an exemplary diagram of a network architecture 100 wherein digital source content are transmitted according to some embodiments of the invention. Digital content herein includes audiovisual (AV) data, visual/image data, audio data, and combinations thereof. In this exemplary embodiment, a local network 100 includes a number of consumer electronics, including a set-top box 134, a wireless digital television (DTV) 130, a personal computer (PC) 142, a DTV 144, a digital video or versatile disc (DVD) player 160, and a computer laptop 148, connected via various network links or segments. These network segments, for example, may include wired, e.g., Ethernet, and/or wireless network segments. In this exemplary embodiment, the set-top box 134 also functions as a media server and a gateway 134. Furthermore, the media server/gateway 134 is connected via one or more wired network segments to a DTV 144. The media server 154 may also be operably connected to a wireless access point and wireless router 102. In these embodiments of the invention, the wireless network devices 130, 134, 160, 142, 148, 154 support the IEEE 802.11a, 802.11g, and optionally 802.11b standards. Other devices that may be coupled to this exemplary network include, but are not limited to, stereo systems, digital cameras and camcorders, multimedia mobile phones, personal digital assistants, and wireless palm computers. This network 100 may be operably coupled to one or more digital content provider sources, for example, via satellite, cable, and/or terrestrial broadcast 138 or via an external wide area network, such as the Internet 190. Digital content thus may be received from content providers via the Internet 190, through, for example, a gateway/wireless router 102, or via broadcasts 138 through a set-top box 134. In some embodiments, content provided by content providers 138, 190 are in analog form. The set-top box 134, which also functions as media server, or any other media server in the network may convert these analog data, e.g., audiovisual data, to their corresponding digital counterparts, e.g., via an analog to digital converter and accordingly processing the video into a proper format, such as Moving Picture Experts Group (MPEG) format. The wireless router 102, in some embodiments, function as a gateway to the Internet as well as an access point for the wireless devices within the network. A media server typically is a device that is the source of a source content, while a media player is typically a device that receives and presents the streaming content elements of the source content into a form that a user may view and/or hear.

In this exemplary LAN 100, a consumer may request an on-demand movie, i.e., the source content. This movie is broadcasted by the satellite 138 and is received by the set-top box 134, which functions as the media server. The set-top box 134, for example, then transmits this source content as streaming content elements, e.g., streaming digital video packers, over wireless network segments. These streaming elements are then received and presented by a media player, for example, the wireless computer 142. Interference, for example, from wireless phones 188, BLUETOOTH™ devices 184, and microwave ovens 180, may also be present in this WLAN, thereby possibly degrading wireless transmissions in the network. Another example of a media server is the DVD player 160 that is operably connected to the network using .11a and .11g network adapters.

FIG. 2 is an exemplary data flow, according to some embodiments of the invention, which provide simultaneous transmission via at least two frequency channels. For example, the content elements 202, e.g., streaming digital AV packets, of a source content are transmitted simultaneously via two network interface adapters 222, 232, e.g., two network interface cards or adapters (NICs). One NIC 222 supports the .11a standard and thus transmits/receives data at 5 GHz, while the other NIC 232 supports the .11g specification and thus transmits/receives at 2.4 GHz. Typically, each of this NIC 222, 232 is designated with its own Internet Protocol (IP) address. The User Datagram Protocol (UDP) may also be employed. In some embodiments, an application-layer protocol is provided that is adapted to handle two UDP connections via two wireless NICS with two different IP addresses.

In this exemplary embodiment, the media server transmits the source content simultaneously via the two frequency channels, e.g., via the two NICs 222, 232. In general, the .11 a NIC 222 transmits over a .11 a wireless network 204, while the .11 g NIC 232 transmits over a .11g wireless network 214. The wireless network 204, 214 of the embodiments of the present invention may be an infrastructure network that utilizes one or more access points, or an ad-hoc/peer-to-peer network, i.e., the media server directly communicates with the client. Typically, the access points deployed in an exemplary infrastructure wireless network of the present invention support simultaneous 2.4 GHz and 5 GHz transmissions/receptions. A number of 802.11a and 802.11g network adapter cards, NICs, and access point devices are currently available from manufacturers such as NETGEAR™ and LINKSYS™. LINKSYS™, for example, has a dual-band wireless router that supports 802.11a, 802.11b, and 802.11g specifications. This multi-function router, model number WRT55AG, also includes two wireless access points supporting 2.4 GHz and 5 GHz. IEEE 802.11b also utilizes the 2.4 GHz. Depending on the embodiments of the invention, the transmission may be a point-to-point, a multicast (one-to-many), or broadcast (one-to-all) communication.

The client devices, e.g., media players, of the exemplary embodiments also typically support two NICs 242, 252—i.e., a .11a interface and a .11g interface. The client device is thus adapted to receive the streaming content element, e.g., packets, sent by the media server via two corresponding network interfaces 242, 252. For example, streaming packets transmitted by the media server at 5 GHz 222 via the .11 a wireless network 204 may be received by the .11a NIC 242 also at 5 GHz, and packets transmitted by the .11g NIC 232 via the .11g wireless network may be received by the appropriate receiving .11g NIC 252. Once the streaming data packets are received from these two interfaces at the client side, the received content elements, e.g., packets, are typically processed, e.g., sorted and redundant packets removed 206. For example, if redundant streaming packets related to the same frame are both received by the .11a interface 242 and by the .11g interface 252, only one of the frames related to the same video frame are displayed or presented in the media player 208. Other conditions to determine which packets are to be discarded or removed from presentation may also be applied, e.g., better quality packets with higher resolution are presented rather than the lower quality packets. Other processing may also be performed, such as filtering content elements, which may depend on defined conditions. This filtering process may include removing or discarding certain content elements and/or selecting certain content elements over other certain content elements, which may be based on defined conditions. The content elements, which may be filtered content elements, are then typically reconstructed in preparation to present the presentation source content to a user.

An example of a .11 a NIC 222, 242 is one from IBM with model number 22P7501. An example of a .11 g NIC 232, 252 is one from LINKSYS™ with model number WUSB54G, Wireless-G USB Network Adapter. In some embodiments, a dual-band NIC that supports both .11 a and .11g specifications may be used, so long as during transmission only one of the frequencies is used. For example, if a dual-band NIC, not shown, is interfacing with the network and is replacing the functions of the .11g NIC 232, the .11a capabilities of that dual-band NIC is typically disabled. Thus, when packets 202 are simultaneously streamed, the exemplary single-band .11a NIC 222 transmits at 5 GHz, while the other exemplary dual-band NIC 232 with its .11a capabilities disabled, transmits at 2.4 GHz. In other embodiments, the server and/or client may have two independent dual-band NICs—with the .11 a interface of one of the dual-band NICs disabled and the .11g interface of the other dual-band NICs also disabled. The client or receiving device may also interface with the network via one or more dual or multi-band NICs, so long as simultaneous reception of streaming packets at two different frequencies are supported. Other variations are expected and still be in the scope of the present invention.

In this exemplary embodiment, the request is for one source content, e.g., the movie “Home of the Range.” The source content is made up of content elements. Some or all of the content elements may be made redundant. The source content, including redundant content elements, may then transmitted over these two frequency channels. At the client or receiver side, however, only one “Home on the Range” movie is presented or played back to a user 208. One of ordinary skill in the art recognizes that any streaming data received at the client side are typically decoded for presentation.

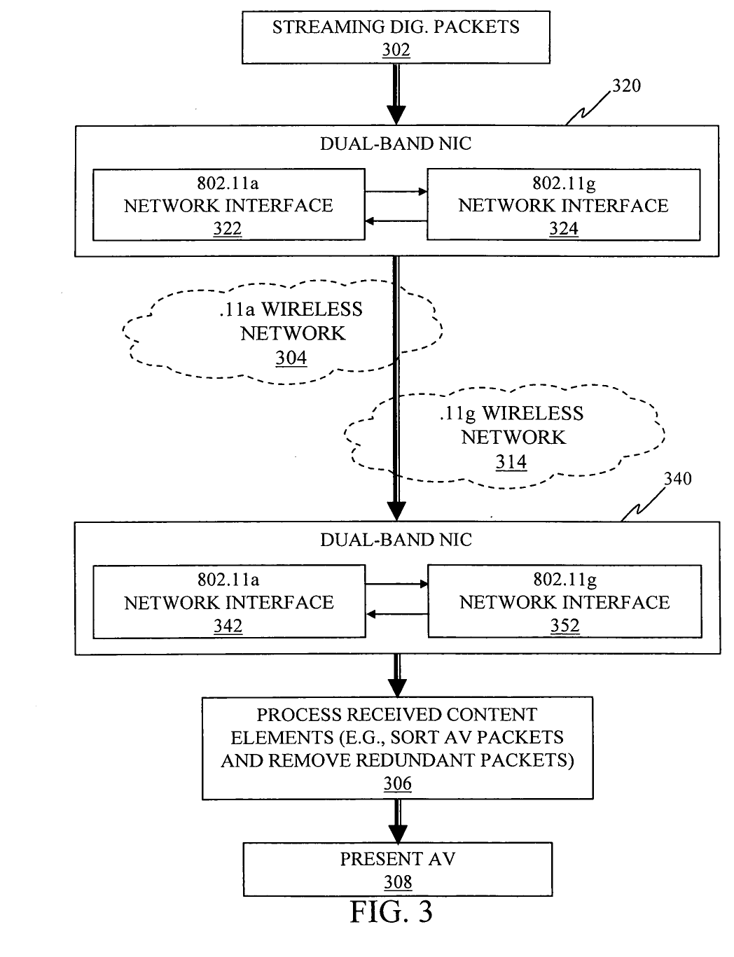

FIG. 3 is another exemplary data flow, according to other embodiments of the invention, which provide alternating/switching transmission between at least two wireless frequency channels. Typically, streaming content elements, e.g., digital packets, 302 are transmitted via a dual-band network adapter or NIC 320. This dual-band NIC supports both the .11a 322 and .11 g 324 specifications and is typically adapted to singly transmit via one of the supported frequency channels at a time, and to switch or alternate transmission from one frequency to the other. An example of a dual-band NIC is one from LINKSYS™ with model number WUSB54AG.

In these exemplary embodiments, transmissions of streaming packets alternate between the two frequency channels, e.g., at 5 GHz alternating with 2.4 GHz. For example, the .11a NIC transmits via the .11a wireless network 304, while the .11g NIC transmits via the .11g wireless network 314. For example, if certain conditions exist, such as the number of lost packets transmitted at 2.4 GHz exceeds a certain threshold, the subsequent streaming packets are typically automatically transmitted—switched—at the other frequency, i.e., 5 GHz. Similarly, the transmission may switch back from 5 GHz to 2.4 GHz, and vice versa, depending on other conditions. In some embodiments, the value of the total switching time may restrict the number of channel switching. When the total switching time is small, e.g., approximately 20 to 40 ms, switching may be performed when short-term BW drops are detected. When the total switching time, however, takes a longer time, a long-term BW average may be used as an indicator for switching conditions/decisions. For example, switching occurs when the long-term BW average drops below the threshold. This threshold may be defined to be a value that is proportional to the video bit-rate (F*Video BitRate). In some embodiments, short-term BW variations may be handled by trans-rating.

In other embodiments, the transmission is periodically switched between the available channels 304, 314, even when the BW is sufficient to support the video stream. This enables the available channel BWs to be probed. In some embodiments, the number of times the switching occurs and the duration of the connections, i.e., before switching to the alternate frequency, may depend on the measured BWs of the channels. The connection duration may, for example, be proportional to the measured BWs. Typically, a longer duration is assigned to the channel with a higher BW, while a lower duration is assigned to the channel with a lower BW. In some embodiments, switching is based on the reception time of feedback messages. Excessive delayed packets may also trigger switching from one channel to another.

The receiving client, e.g., media player, typically includes a dual-band NIC 340, which is adapted to receive the streaming packets conforming to .11a 342 and to .11g 352 specifications. In these exemplary embodiments, streaming data transmitted by the .11a NIC 322 via the .11a wireless network 304 are received by the .11a NIC 342 counterpart at the client side. Similarly, streaming data transmitted by the .11g NIC 324 via the .11g wireless network 314 are received by the .11g NIC 352. The client dual-band NIC 340, similar to the source, switches between the .11a interface and the .11g to accordingly receive data transmitted by the media server. In some embodiments, the received packets via the two wireless channels are further processed, for example, filtered, sorted, and/or reconstructed 306. Filtering, herein, includes selecting certain content elements and/or removing/discarding certain packets. The appropriate packets are then typically presented or played 308 in a media player, e.g., the movie or music played. In some embodiments, the client/receiving device has two independent single-band NICs, rather than just one dual-band NIC. In this exemplary embodiment, one independent single-band NIC supports .11 a specification, while the other NIC supports the .11 g specification.

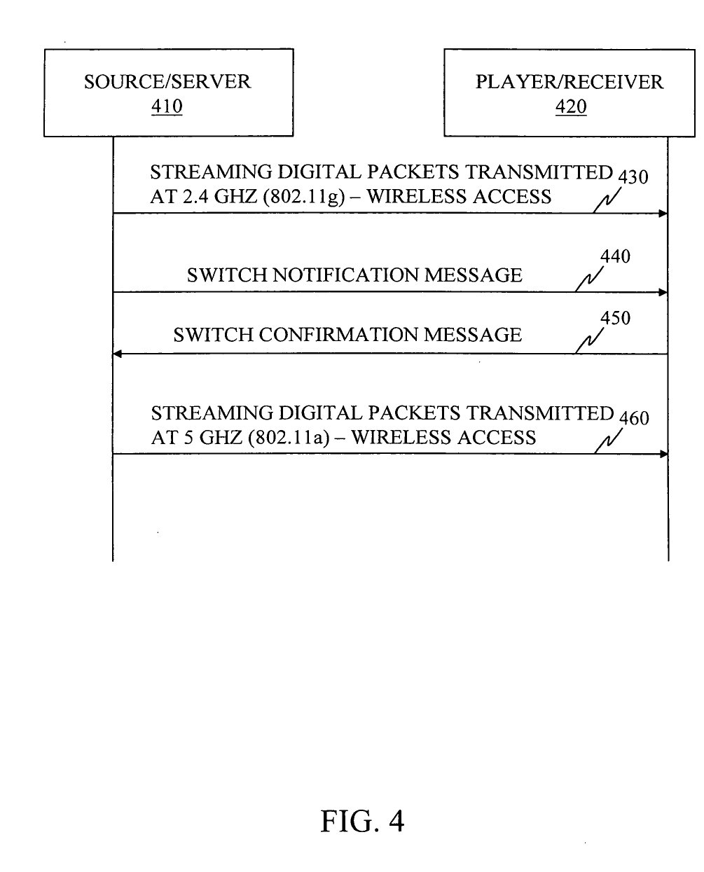

FIG. 4 is a high-level data flow diagram between a source/server 410 and a receiver/client 420, wherein the server and the client notify each other that the channel is going to be switched. These exemplary exchanges typically apply to embodiments that dynamically switch or alternate frequencies, e.g., see FIG. 3. For illustrative purpose, let us assume that the server is currently streaming packets at 2.4 GHz 430, i.e., via the .11g interface 324 of the dual-band NIC 320. The server 410 detects interference from wireless phones. In some embodiments, the server performs bandwidth (BW) estimation to determine whether the BW of the 2.4 GHz frequency channel is below a defined threshold. Based on that determination, the server 410 may then send a switch notification message 440 to the client 420, informing the client that the server 410 is going to transmit at the alternate frequency, i.e., at 5 GHz. To confirm, the client 420 sends a switch confirmation message 450 informing the server 410 that the client is ready to receive at the alternate frequency. Once the server receives this confirmation 450, it 410 then starts streaming packets 460 via the .11a interface 322 of the dual-band NIC 320. In some embodiments, if the switch confirmation message 450 is not received within a predetermined or predefined time-out period, the switch notification message 440 may be retransmitted×number of times, depending on system design and implementation.

The device that is responsible or performs the BW estimation may generate the switch notification message 440. Furthermore, the notification and confirmation messages 440, 450 may be generated at the application layer, for example, by a set of programmed instructions executing at the client and/or server. The switch notification message 440 may also include the time, e.g., as a time offset or clock time, when the switch is going to commence. In some embodiments, the client 420 initiates the switch notification message informing the server to change frequency and to start transmitting at that frequency at a defined time.

Recovery of unsuccessful transmissions on failed links or links that have degraded below a certain threshold may also be performed via packet reassignments. Unacknowledged packets, e.g., at the application layer, may be retransmitted over the new connection, i.e., at the other or alternate frequency channel. In some embodiments, these streaming data are dropped or trans-rated when the delay constraints are violated.

Furthermore, within the media server and/or the client, i.e., intra-device, if switching between channels is employed, the .11a 322, 342 and the .11g 324, 352 NICs may send messages between each other. These messages may be similar to the switch notification and/or confirmation messages.

In general, depending on implementation, the server or media server performs a number of functions that prepare the source content for transmission over the wireless channels. These functions may include generating redundant content elements, including exact duplicates, transcoding or adapting content elements, partitioning the source content, etc. The client or media player, on the other hand, may perform some functions that prepare the source content to be presented, e.g., video processing tasks. Some of these functions may include sorting, filtering, and reconstructing content elements. These functions are further explained below.

FIG. 5 is a data flow of some exemplary embodiments of the invention, wherein redundant copies of the same source content are transmitted simultaneously via the two frequency or wireless channels. FIG. 5 is discussed together with FIG. 2. In this exemplary embodiment, there is one source content that is made redundant 502, i.e., the first frequency channel 522 transmits the same source content that is being transmitted by the second frequency channel 532. For example, the same “Home on the Range” movie is transmitted via those two channels. At the client or receiver, however, only one “Home on the Range” movie is presented or played back to a user. In some embodiments, the media or source server generates redundant content elements, so one source content may be sent via the .11 a link 522 while the other same source content, “Home on the Range,” may be transmitted, typically simultaneously, via the .11g link 532. Other server processing may also be performed to prepare the source content for transmission.

In the various embodiments of the present invention, the streaming content elements, for example, packets that make up the source content may be exact duplicate copies, e.g., same compression format, same bit rate, same frame rate, etc. In other embodiments of the present invention, the streaming parts that make up the source content are not exact duplicates, i.e., there are variations, such as different bit rates, different frame rates, different resolution, and/or different file formats. Thus, a duplicate source content typically means a duplicate source content at a higher level, e.g., same movie “Home on the Range,” but the underlying content elements that make up or are part of the source content may be redundant content elements, which in some cases may mean exact duplicate content elements—i.e., with no variations. Thus, e.g., “Frame 5” of the “Home on the Range movie” may be transmitted via .11a link 522 with y resolution, and the same “Frame 5” transmitted at z resolution at the .11g link 532. “Frame 5” at the .11a and “Frame 5” at the .11 g are not exact duplicate content elements.

For illustrative purposes, an on-demand movie is being transmitted as streaming video packets. The same on-demand movie, i.e., redundant AV elements, is simultaneously streamed via the .11a interface 222, 522 and .11g interface 232, 532. Typically, the client and the server each have two independent single-band NICs 522 and 532, 542 and 552. If streaming packets transmitted at 2.4 GHz 532 are, for example, lost or late, due to BLUETOOTH™ device interference, the corresponding redundant streaming packets at the other simultaneously transmitting channel 522 may still be received at the client 552, thereby potentially improving media quality presentation to a user.

The client/media player typically processes the received content elements, e.g., sort and remove redundant packets 506, and accordingly present or play the streaming video packets 508, for example, to a user to be viewed on a monitor 130. In some embodiments, the client may sort, filter, and/or reconstruct the content elements received from the two wireless channels, typically prior to presenting the source content to the user. This simultaneous transmission of redundant streaming packets may be effectively employed when the average bandwidth of both .11a and .11g channels are typically higher than the transmitted video bit-rates. In these exemplary embodiments, BW estimation and/or trans-rating is typically not performed by the server or the client.

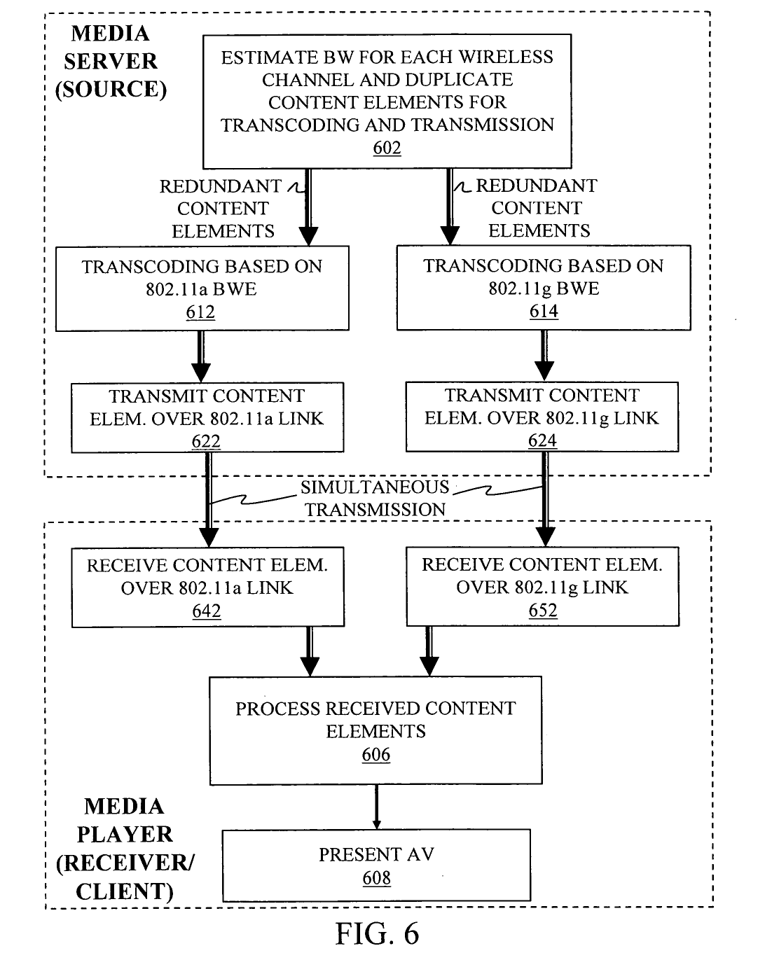

FIG. 6 is a data flow of another exemplary embodiment of the invention, where redundant copies of the same source content are transmitted via two frequency channels. In this embodiment, each channel's condition is determined or at least estimated, and the content elements are duplicated or made redundant 602 for transcoding 612, 614 and transmission 622, 624. For example, BW estimation is performed for each wireless channel—i.e., for 2.4 GHz/.11g and 5 GHz/.11a. Transcoding may be performed to match limitations, e.g., channel, transmission, storage and/or buffer, processing, and/or display capability limitations of the network, terminals, and/or display devices. Transcoding operations may include bit rate reduction, spatial down sampling, frame rate reduction, and changing compression formats. Examples of compression formats include MPEG-4 and H.263 V2 formats. BW may be one of the indicators of channel condition, but other channel-condition indicators, as known to those of ordinary skill in the art, may also be considered, e.g., feedback of packet losses, packet loss ratios, and/or round-trip time (RTT) statistics. The streaming content elements 602 may be transcoded 612, 614 based on the channel condition via which they are going to be transmitted; and simultaneously transmitted over the two channels 622, 624. Thus, redundant, not exact duplicate, copies of each content element, e.g., video frame or video slices, at different rates may be simultaneously transmitted. The client 420 may simultaneously receive frames or slices sent by the server, via the client's corresponding network interfaces 642, 652. The client typically processes the received content elements 606, which may include sorting, filtering, and/or reconstruction of frames. For example, the received content elements may be sorted and redundant content elements removed—typically at decoding. In some embodiments, frames/slices that are discarded may be based on the quality and/or timing of the received content elements. The sorted and filtered content elements are then typically decoded and played back/presented 608 to the user.

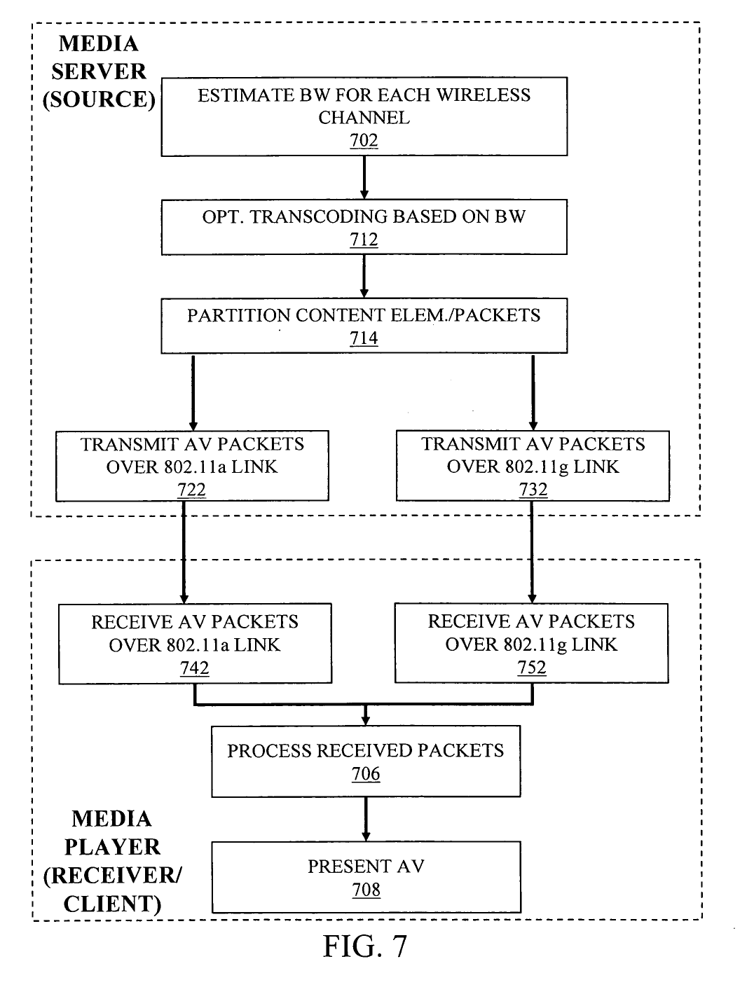

FIG. 7 is another exemplary data flow according to other embodiments of the invention. In this embodiment, the source content is not duplicated, i.e., there are no two copies of the source content, but rather the source content is divided between the two frequency channels. In general, each channel condition is determined or estimated 702. The allocation of which content elements, e.g., packets in this example, are to be transmitted via which frequency channel may depend on that channel's condition, e.g., proportional to that channel's BW estimate, e.g., more packets are transmitted over the channel having the higher BW. The buffer size and/or buffer-fullness condition of the server and/or the client may also be considered in determining packet assignment to channels, e.g., to consider playback delay-constraints or latency. In some embodiments, the server channel that has a fuller buffer or higher server buffer occupancy is assigned fewer packets, because this channel may have to wait more time prior to transmission. In some embodiments, optional transcoding 712 may be performed, e.g., when the aggregate BW of the two channels drops below the video rate. The transcoded content elements are then partitioned 714, i.e., certain content elements are assigned to one wireless channel, while the rest of the content elements of that source are assigned to the other wireless channel. In some embodiments, the partitioned packets of the source content are assigned to each channel in an interleaving manner, which may improve decoder error concealment processes.

The packets assigned to their appropriate channels 722, 732 are thus accordingly transmitted. The packets may then be received at the client side 742, by the appropriate receiving channel or network interface 742, 752. The packets that are received may then be processed, e.g., sorted and reconstructed, and accordingly presented, for example, via a display device and/or an audio device 708.

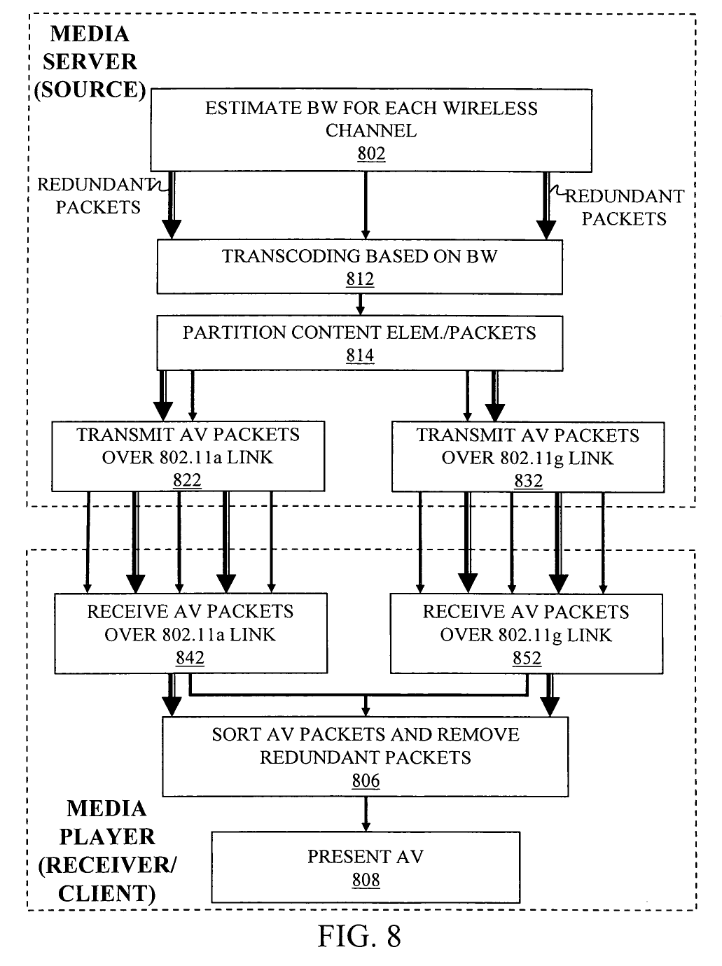

FIG. 8 is a variation of FIG. 7. In this exemplary embodiment, redundant copies of selected content elements, e.g., packets, of the source content are transmitted in addition to the partitioned source content 802 discussed in FIG. 7. Thus, in this exemplary embodiment, there is one source content partitioned between the two wireless channels, and portions of the source content are then made redundant. Thus, the server in some embodiments generates duplicate sections of the source content. Whether a content element or packet is going to be made redundant may depend on a number of factors, including BW availability, e.g., the more BW availability, the more redundant packets. This redundancy may also depend on the coding algorithm used to encode the packets. For example, MPEG videos support various frame types; with I-frame packets deemed the most important, the P-frames having a medium importance, and the B-frames being the least important. In this exemplary embodiment, all the I-frames are made redundant or at least portions thereof, and these redundant packets are also transmitted over the channels 822, 832.

In general, this operation may include BW estimation for each channel 802, transcoding the source content and the duplicate sections/portions of the source content 812, and partitioning the transcoded elements to the appropriate channels 814. The manner in which the source content is partitioned between the two wireless channels may be similar to that discussed in FIG. 7. The channel or interface, over which the redundant packets, i.e., the duplication sections, is transmitted may depend on a number of factors, e.g., similar to those factors that determine the partitioning of the source content between the two channels. The streaming content elements and their redundant counterparts may also be transmitted simultaneously in both channels 822, 832, e.g., I-frame n via the .11a channel 822, and the redundant I-frame n via the other channel .11g 832.

The packets are typically transcoded based on the associated channel condition 812, 814 and transmitted via the appropriate channels 822, 832. The packets, including redundant packets, may be received at the appropriate receiving channels 842, 852, and are processed by the client, e.g., sorted with redundant packets discarded 806. The streaming packets are then accordingly presented 808 to the user as a streaming video, for example.

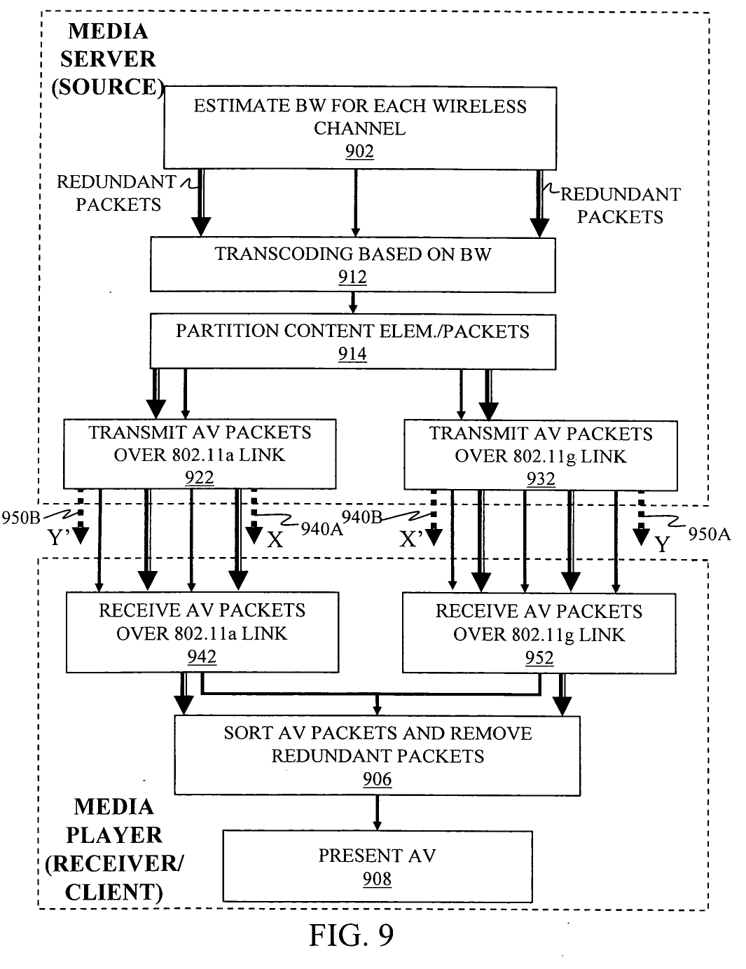

FIG. 9 is another exemplary embodiment, similar to FIG. 8, but with some variations. The processes in FIGS. 8 and 9 provide for partial duplication and redundancy. There are, however, streaming content elements, e.g., packets, that do not have corresponding redundant counterparts and may potentially be lost or delayed in transmission. In some embodiments, when a packet is not acknowledged with an appropriate feedback message within a predetermined amount of time, that lost packet X 940A is reassigned, i.e., retransmitted at the alternate frequency channel X′ 940B. Thus, if a packet Y 950A transmitted at the .11g frequency channel 950A is, for example, unacknowledged within a defined condition, that packet Y is retransmitted at the other .11a frequency channel Y′ 950B. In some embodiments, the application layer may wait for an acknowledgement and if none is received or is received too late, the application layer transfers that lost packet Y 950A to the alternate frequency Y′ 950B for transmission. This exemplary process thus provides a retransmission-based loss recovery feature.

Similar to FIG. 8, this process may include BW estimation for each channel 902, transcoding the source content and the duplicate sections/portions of the source content 912, and partitioning the transcoded elements to the appropriate channels 914. The manner in which the source content is partitioned between the two wireless channels may be similar to that discussed above. The content elements are simultaneously transmitted over the two wireless links 922, 932, with lost or late packets being retransmitted at the alternate wireless channel. The packets which are received by the client via the corresponding NICs 942, 952, are accordingly processed. Typically, this may include sorting, filtering, and reconstructing the received packets 906. These packets are then accordingly presented 908. Sorting may include ordering the content elements.

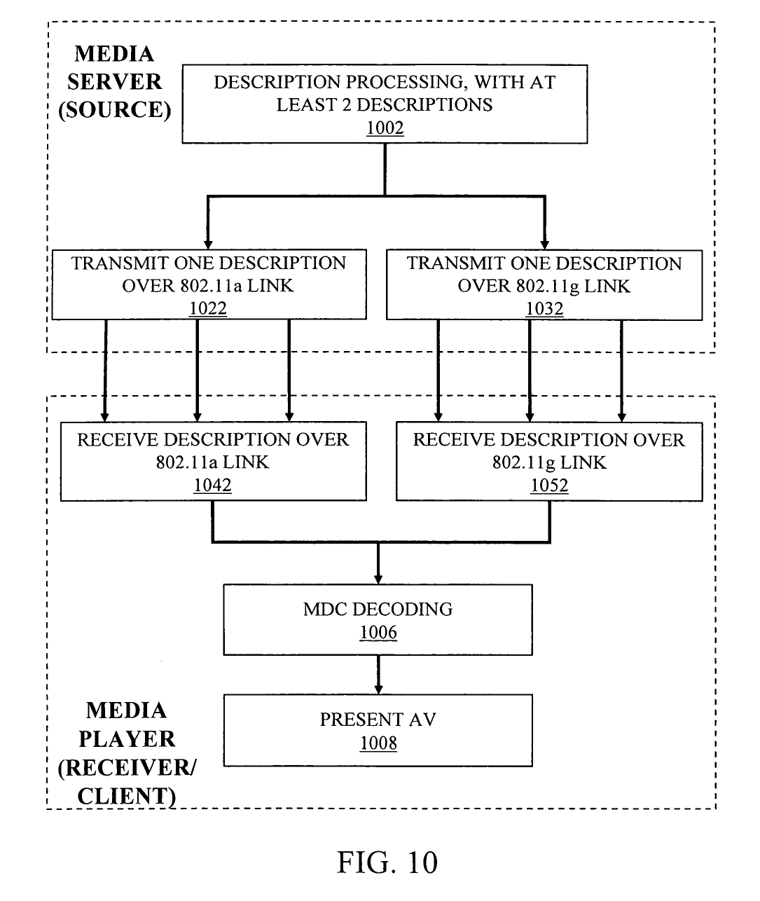

FIG. 10 is another exemplary embodiment of delivering source content to a client/receiver. In a multiple description coding (MDC) scheme, a signal is typically coded into two or more separate bitstreams. Each bitstream is typically referred to as a description. Each description typically may be independently decoded to provide a usable reproduction of the original signal. Each description also typically contains complementary information such that the quality of the decoded signal improves with the number of descriptions correctly received. In some embodiments, the rate of each description is adjusted based on the statistics/measurements of the wireless channel over which the description is to be or being transmitted. Description coding thus may provide a useful playback or presentation when any description is received, and may provide increasing quality as more descriptions are received.

In this exemplary embodiment, a multiple description coded (MDC) codec, for example, generates two descriptions 1002, with each description assigned to a different frequency channel. One description is thus transmitted via the .11a channel 1022 and the other description via the .11g channel 1032. If more than two descriptions are generated, these descriptions are divided over the available frequency channels. The received descriptions 1042, 1052 are decoded, e.g., by an MDC decoder 1006 and the video presented for viewing 1008. If the two descriptions, for example, are received at the appropriate receiving channels 1042, 1052, full quality video may be presented. If one of the frequency channel experiences interference that cause one of the descriptions to be lost, there is still an opportunity for the other description to be received at the client.

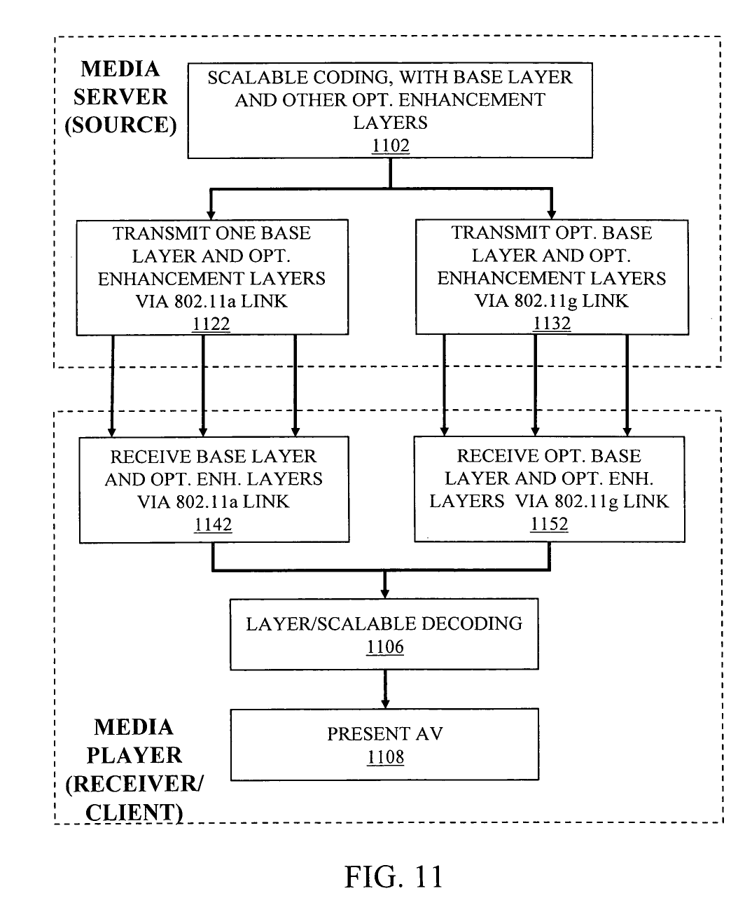

FIG. 11 is another exemplary embodiment but the streaming video is a scalable or layered video. Unlike the MDC scheme, the scalable or layered scheme provides a base layer, which is typically needed to present the streaming data to the user. In this embodiment, the source content is encoded to provide a base layer and one or more enhancement layers, e.g., via a video layer codec 1102. The number of enhancement layers may depend on certain conditions, e.g., the available BW and channel condition. The base layer is typically made redundant such that one base layer is transmitted at the .11a channel 1122 and the other redundant base layer at the .11g channel 1132. This redundancy provides a greater chance of at least one base layer being received at the client side. In some embodiments, only one base layer is sent. The received layers 1142, 1152 are then decoded 1106, e.g., by a scalable codec, and then presented to a user 1108.

Referring back to FIG. 3, the various embodiments described herein may also be used and/or modified such that transmissions may be switched from one frequency channel to another. For example, if a video stream is represented as two descriptions, the exemplary process of the present invention transmits the first description on one of the available channels, e.g., .11a channel. If that .11a channel, however, results in inferior performance, the server and/or the client, may request that the transmission be switched to the alternate .11 g channel. This feature of dynamically switching back and forth/alternating between available channels, thus, provides a seamless process, which improves streaming video data delivery from a server to a client.

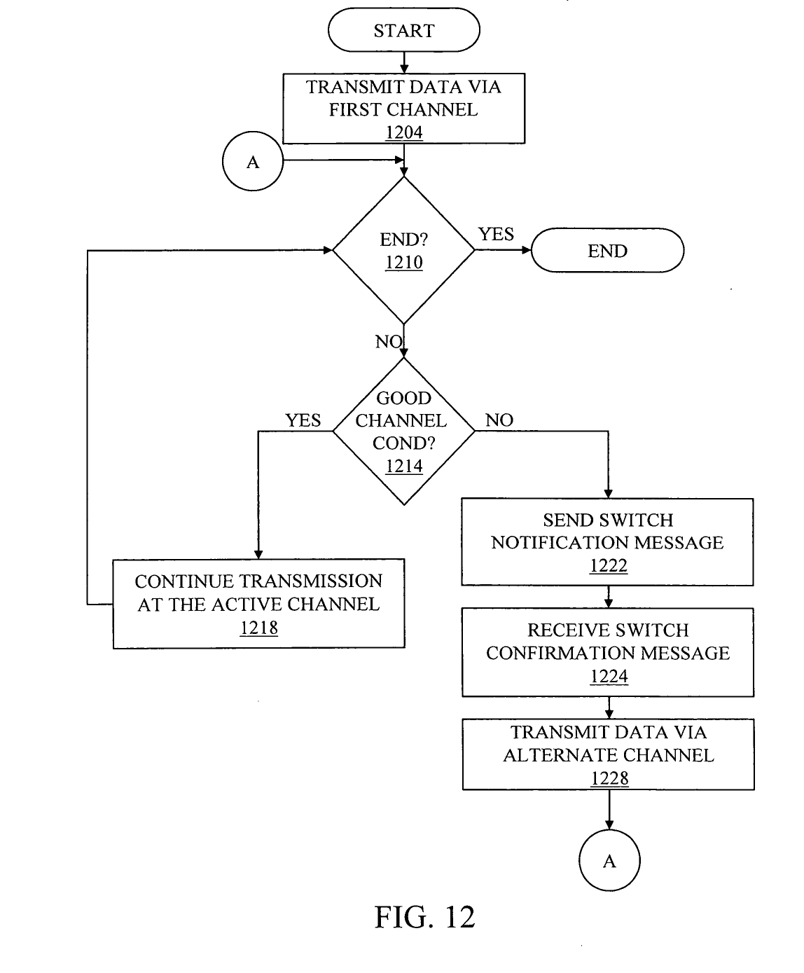

FIG. 12 is a high-level flowchart on a process wherein the transmission is switched from one channel to another. Typically, the streaming content elements of a source content are transmitted over a first channel, e.g., .11a wireless channel (step 1204). In the next operation, a check is made whether it is the end, e.g., the end of the source content such as an on-demand video or the end of a videoconferencing session (decision 1210). If there is more streaming content elements, a check is made to determine whether the active channel meets a certain condition, e.g., is a good channel, e.g., because of BW estimation (decision 1214). In other embodiments, this may be triggered by receiving feedback information, e.g., indicating too much packets lost in the active channel, too much interference, too little bandwidth, etc. This decision may be triggered by outside factors. If the channel is a good channel, the streaming content elements are continued to be transmitted at that active channel (step 1218). However, if the active channel is not a good channel or fails to meet a certain threshold or condition, the server and/or client sends a switch notification message (step 1222) and accordingly waits for a switch confirmation message (step 1224). The notification message may be sent a number of times, if appropriate. Once the confirmation message is received, the server starts transmitting at the alternate channel (step 1228). This switching feature thus enables the rest of a movie, for example, be streamed over a channel with better channel condition. This switching process may be performed a number of times, e.g., during the time a single on-demand movie is streamed to a client device. Viewing it another way, the switching mechanism may be performed a number of times within one session, wherein a session is defined by the duration to stream, e.g., an entire movie content, or by a duration defined from the start of a videoconferencing until no more signal is received. Other manner of defining a session may also be applied. In some embodiments, more than two wireless channels are available from which alternating transmission may occur. In other embodiments, not shown, the wireless channel switches from a 0.11a channel to an 802.11b channel, rather than a .11g channel, e.g., a .11a and an 802.11b combination.

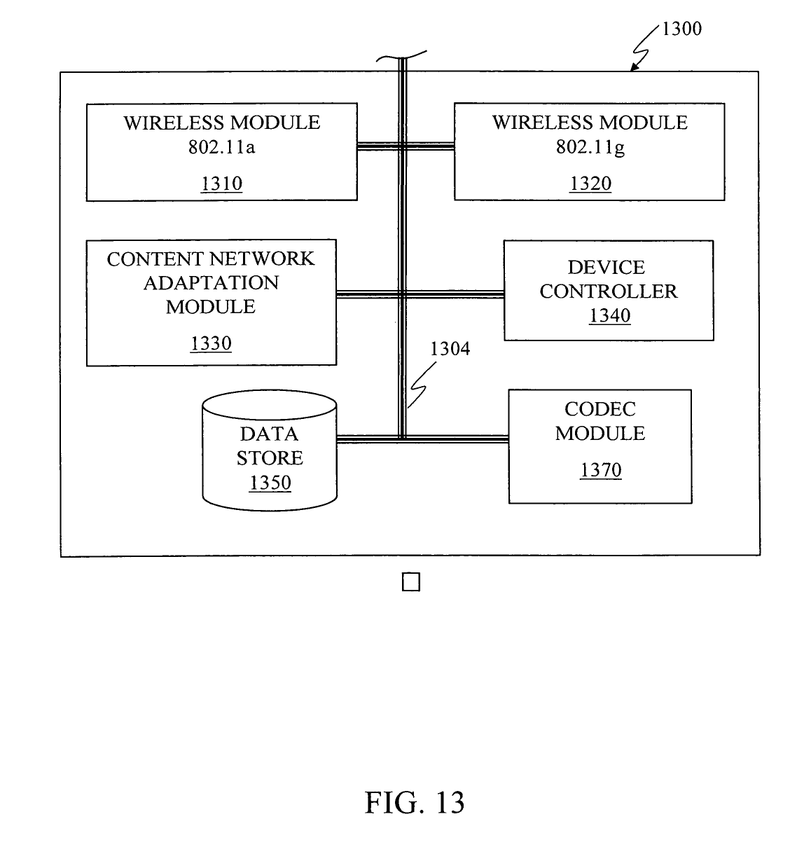

FIG. 13 is a high-level functional block diagram of an exemplary device 1300 that is adapted to be operably coupled to a wireless network via one or more network segments. This device 1300 is adapted to communicate via at least two wireless channels, for example, via an 802.11 wireless module 1310 and an 802.11g wireless module 1320. These two modules may be contained in one single dual-band NIC or contained in two independent single-band NICs, depending on implementation. In some embodiments, there may be more than two interfaces, with corresponding wireless channels. The device 1300 also includes a content network adaptation module 1330, which at a high-level adapts the source content to the network. This content network adaptation module is adapted to perform certain functions, including network monitoring functions and video or source content processing functions 1330. Examples of functions it 1330 may perform include bandwidth estimation; sending and receiving feedback messages, e.g., whether content elements have been received or not, including RTTs; querying the NIC type of the other device in the system, e.g., .11a NIC and dual-band NIC; determining based on the NIC type(s) of the device and/or other device within the system, whether transmission/reception is going to be performed simultaneously or in an alternating manner (switching); retransmitting lost or delayed content elements; generating redundant content elements; performing transcoding functions, including trans-rating, if appropriate; performing rate-adaptation functions; partitioning of content elements to the appropriate wireless channels; determining which sections or portions of the source content is to be made redundant, including whether they should be exact duplicates or not; and/or instructing which wireless modules 1310, 3120 are going to be utilized for transmission/reception, e.g., during simultaneous transmission or alternating transmission. If the device is a media player or a receiver, for example, the content network adaptation module may include functions, such as sorting, filtering, and/or reconstructing the content elements. A media player/client device, for example, may also have a display and/or a speaker, not shown, enabling a user to experience the streaming source content. Variations on the functions performed by the content network adaptation module 1330 may depend on various conditions, including implementation issues, whether the device functions as a media server and/or as a media player, and/or the type of source content, e.g., audio, visual, or audiovisual. The content network adaptation module 1330 may be implemented in the application layer, e.g., as a set of programmed instructions via software.

The data store 1350 may be volatile and/or non-volatile memory, which may also include the buffer to temporarily contain incoming/outgoing streaming data. The device controller 1340 typically manages and controls the entire device 1300. The codec module 1370 may perform the encoding/decoding, including compression and decompression, of streaming data, e.g., it may be adapted to perform scalable layer encoding/decoding, MDC encoding/decoding, MPEG, etc.

In some embodiments of the invention, the different modules 1310, 1320, 1330, 1340, 1350, 1370, all or portions thereof, may communicate and interface with each other via a bus, dedicated signal paths 1304. An application layer module, not shown, may also be added to manage and handle the two IP addresses of two independent single-band NICs. Depending on the functions of the device, other modules, including functions and capabilities, may be added or removed. For example, a set-top box may have a user interface module adapted to present information to the users, such as graphically presenting content for consumers to view. Furthermore, the modules described herein may be combined into one module to perform some or all functions of the various modules. Furthermore, the modules described herein may be further subdivided and combined with other functions so long as the function and processes described herein may be performed. The various modules may also be implemented in hardware, software, or both, i.e., firmware.

The source content of the embodiments of the present invention may also consist of various types of content elements. For example, the content elements may be packets, frames, group of pictures, slices, and other data units. Furthermore, the formatting or data format or specification may include various types or formats, including MPEG format, scalable format, non-scalable format, description-coded format, etc.

Embodiments of the present invention may be used in conjunction with other wireless networks, systems, and devices. Although this invention has been disclosed in the context of certain embodiments and examples, it will be understood by those or ordinary skill in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of ordinary skill in the art based upon this disclosure. It is also contemplated that various combinations or subcombinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above.

We claim:

1. A method of delivering, via a server, a streaming source content comprising a set of content elements, the method comprising the steps of:
transmitting, by the server, via a first wireless channel at least one streaming content element of the source content; and
transmitting, by the server, via a second wireless channel at least one streaming content element of the source content, the second wireless channel different from the first wireless channel, and wherein the step of transmitting via the second channel is selected from at least one of the following:
performed simultaneously with the step of transmitting via the first channel; and
performed in an alternating manner with the step of transmitting via the first channel.

2. The method of claim 1 wherein the set of content elements, of the source content, comprises at least one of the following:
a packet;
a slice;
a frame;
a group of pictures.

3. The method of claim 1 wherein the at least one streaming content element via the first channel is an exact duplicate of the one streaming content element via the second channel.

4. The method of claim 1 wherein the at least one streaming content element via the first channel is a redundant copy of one of the at least one streaming content element via the second channel, comprising at least one variation from the at least one streaming content element via the first channel.

5. The method of claim 1 wherein the first channel is selected from at least one of the following:
a 5 GHz wireless channel; and
a 2.4 GHz wireless channel.

6. The method of claim 5 wherein the second channel is selected from at least one of the following:
a 5 GHz wireless channel, when the first channel is the 2.4 GHz channel; and
a 2.4 GHz wireless channel, when the first channel is the 5 GHz channel.

7. The method of claim 1 wherein the first channel supports at least one of the following:
IEEE 802.11a; and
IEEE 802.11g.

8. The method of claim 1 wherein the at least one streaming content element via the first channel is a multiple description coded content element.

9. The method of claim 1 wherein the at least one streaming content element via the first channel is at least one of the following:
a scalable coded base layer content element; and
a scalable coded enhancement layer content element.

10. The method of claim 1 wherein the at least one streaming content element via the first channel is at least one of the following:
a conventional non-scalable formatted content element; and
a conventional non-multiple description formatted content element.

11. The method of claim 10 wherein the conventional non-scalable formatted content element is a Moving Picture Experts Group (MPEG) format.

12. The method of claim 1 wherein the source content is at least one of the following:
audio data;
visual data; and
audiovisual data.

13. The method of claim 1 further comprising at least one of the steps of the following:
generating at least one redundant content element of the source content;
generating at least one exact duplicate content element of the source content;
monitoring channel conditions of the first wireless channel and the second wireless channel;
transcoding at least one content element of the source content; and
partitioning the source content, wherein a first portion of the set of content elements is transmitted via the first channel and a second portion of the set of content elements is transmitted via the second channel.

14. The method of claim 13 wherein the first portion of the set of content elements and the second portion of the set of content elements are redundant with each other.

15. The method of claim 1 further comprising the steps of:
receiving via the first channel the at least one streaming content element transmitted via the first channel; and
receiving via the second channel the at least one streaming content element transmitted via the second channel.

16. The method of claim 15 wherein the step of receiving via the second channel is selected from at least one of the following:
performed simultaneously with the step of receiving via the first channel; and
performed in an alternating manner with the step of receiving via the first channel.

17. The method of claim 15 further comprising at least one of the steps of the following:
filtering the received content elements from the first channel and the second channel;
sorting the received content elements from the first channel and the second channel; and
reconstructing the received content elements from the first channel and the second channel in preparation for presenting the source content.

18. The method of claim 1 further comprising the steps of:
transmitting a switch notification message; and
receiving a switch confirmation message.

19. The method of claim 1 further comprising at least one of the steps of the following:
retransmitting, by the server, via the second wireless channel at least one streaming content element previously transmitted via the first wireless channel; and
retransmitting, by the server, via the first wireless channel at least one streaming content element previously transmitted via the second wireless channel.

20. A media server adapted to be operably coupled to a wireless network and to deliver a streaming source content comprising a set of content elements, the device comprising:
a first wireless channel interface;
a second wireless channel interface, the second wireless channel interface different from the first wireless channel interface; and
a content network adaptation module adapted to:
transmit via the first channel interface at least one streaming content element of the source content; and
transmit via the second channel interface at least one streaming content element of the source content, wherein the transmission via the second channel interface is at least one of the following:
performed simultaneously with the transmission via the first channel interface; and
performed in an alternating manner with the transmission via the first channel interface.

21. The device of claim 20 wherein the first channel interface is adapted to transmit from at least one of the following:
at 5 GHz; and
at 2.4 GHz.

22. The device of claim 21 wherein the second channel interface is adapted to transmit from at least one of the following:
at 5 GHz frequency, when the first channel interface is adapted to transmit at the 2.4 GHz; and
at 2.4 GHz, when the first channel interface is adapted to transmit at the 5 GHz.

23. The device of claim 20 wherein the content network adaptation module is further adapted to:
transmit a switch notification message; and
receive a switch confirmation message.

24. The device of claim 20 wherein the content network adaptation module is further adapted to perform at least one of the following:
generate at least one redundant content element of the source content;
generate at least one exact duplicate content element of the source content;
monitor channel conditions of a first wireless channel associated with the first wireless channel interface and of a second wireless channel associated with the second wireless channel interface;
transcode at least one content element of the source content; and
partition the source content, wherein a first portion of the set of content elements is transmitted via the first channel interface and a second portion of the set of content elements is transmitted via the second channel interface.

25. The device of claim 20 wherein the content network adaptation module is further adapted to perform at least one of the following:
retransmit via the second wireless channel interface at least one streaming content element previously transmitted via the first wireless channel interface; and
retransmit via the first wireless channel interface at least one streaming content element previously transmitted via the second wireless channel interface.

26. The device of claim 20 wherein the source content is at least one of the following:
audio data;
visual data; and
audiovisual data.

27. A media receiver adapted to be operably coupled to a wireless network and to receive a streaming source content from a server, the device comprising:
a first wireless channel interface;
a second wireless channel interface, the second wireless channel interface different from the first wireless channel; and
a content network adaptation module adapted to:
receive via the first channel interface at least one streaming content element of the source content; and
receive via the second channel interface at least one streaming content element of the source content, wherein the reception via the second channel interface is at least one of the following:
performed simultaneously with the reception via the first channel interface; and
performed in an alternating manner with the reception via the first channel interface.

28. The device of claim 27 wherein the first channel interface is adapted to receive from at least one of the following:
at 5 GHz; and
at 2.4 GHz.

29. The device of claim 27 wherein the second channel interface is adapted to receive from at least one of the following:
at 5 GHz frequency, when the first channel interface is adapted to receive at the 2.4 GHz; and
at 2.4 GHz, when the first channel interface is adapted to receive at the 5 GHz.

30. The device of claim 27 wherein the content network adaptation module is further adapted to perform at least one of the following:
filter the received content elements from the first channel interface and the second channel interface;
sort the received content elements from the first channel interface and the second channel interface; and
reconstruct the received content elements from the first channel interface and the second channel interface in preparation for presenting the source content.

31. A system comprising:
at least one wireless network segment operably coupling a media server and a media receiver;
the media server comprising:
a first wireless channel interface;
a second wireless channel interface, the second wireless channel interface different from the first wireless channel interface; and
a content network adaptation module adapted to:
transmit via the first channel interface at least one streaming content element of the source content; and
transmit via the second channel interface at least one streaming content element of the source content, wherein the transmission via the second channel interface is at least one of the following:
performed simultaneously with the transmission via the first channel interface; and
performed in an alternating manner with the transmission via the first channel interface; and
the media receiver comprising:
a first wireless channel interface;
a second wireless channel interface, the second wireless channel interface different from the first wireless channel; and
a content network adaptation module adapted to:
receive via the first channel interface at least one streaming content element of the source content; and
receive via the second channel interface at least one streaming content element of the source content, wherein the reception via the second channel interface is at least one of the following:
performed simultaneously with the reception via the first channel interface; and
performed in an alternating manner with the reception via the first channel interface.
